(19) United States
(12) Patent Application Publication
(10) Pub. No.: US 2008/0126646 A1
(43) Pub. Date: May 29, 2008

(54) Server

(76) Inventors: Motoe Sakanaka, Osaka (JP); Keiji Hirao, Osaka (JP)

Correspondence Address: KRATZ, QUINTOS & HANSON, LLP, 1420 K Street, N.W., Suite 400, WASHINGTON, DC, 20005, US

(21) Appl. No.: 11/665,457

(22) PCT Filed: Oct. 11, 2005
(86) PCT No.: PCT/JP05/18998

§ 371 Date: Apr. 16, 2007

(30) Foreign Application Priority Data
Oct. 20, 2004 (JP) 2004-305114

(51) Int. Cl. G06F 13/372

(52) U.S. Cl. 710/119

(57) ABSTRACT

When accepting a send request for requesting to send a command to a client from a terminal (mobile phone, PC), a server determines terminal types. When the determination result shows a PC, a command is sent to the client, and an execution result of the sent command is received from the client, and the received execution result is sent to the PC. When the determination result shows a mobile phone, the client is instructed to issue a port releasing request to request a router to release an arbitrary port, a number of the released port is acquired from the client, and the mobile phone is instructed to send the command to the destination specified by the destination information including the acquired port number.

### TECHNICAL FIELD

The present invention relates to a server. More specifically, the present invention relates to mediate a data communication between a command processing apparatus and a process requesting apparatus.

### PRIOR ART

One example of a conventional server of such a kind is disclosed in Japanese Patent Laying-open No. 2003-249943 laid-open on Sep. 5, 2003. In the related art, when accepting a send request for request to send a command to a command processing apparatus (camera) from a process requesting apparatus (client PC), a server sends a command to the command processing apparatus, receives an execution result of the sent command from the command processing apparatus, and sends the received execution result to the process requesting apparatus.

In the related art, it is possible to surely mediate a data communication between the command processing apparatus and the process requesting apparatus. However, if the execution result includes a large amount of data such as a motion image, etc., a heavy load is imposed.

### SUMMARY OF THE INVENTION

Therefore, it is a primary object of the present invention to provide a novel server.

Another object of the present invention is to provide a server capable of surely mediate a data communication between a command processing apparatus and a process requesting apparatus while reducing the load.

A server according to an invention of claim 1 comprises a determining means for, when a send request for requesting to send a command to a command processing apparatus is accepted from a process requesting apparatus, determining whether or not the process requesting apparatus satisfies a predetermined condition, a first sending means for sending the command to the command processing apparatus when a determination result by the determining means is negative, a receiving means for receiving from the command processing apparatus an execution result of the command sent by the first sending means, a second sending means for sending the execution result received by the receiving means to the process requesting apparatus, a first instructing means for instructing the command processing apparatus to perform preparation processing for receiving the command when the determination result by the determining means is affirmative, and a second instructing means for instructing the process requesting apparatus to directly send the command to the command processing apparatus in association with an instruction by the first instructing means.

A determining means, when a send request for requesting to send a command to a command processing apparatus is accepted from a process requesting apparatus, determines whether or not the process requesting apparatus satisfies a predetermined condition. When a determination result by the determining means is negative, a first sending means sends the command to the command processing apparatus. A receiving means receives from the command processing apparatus an execution result of the command sent by the first sending means, and a second sending means sends the execution result received by the receiving means to the process requesting apparatus. When the determination result by the determining means is affirmative, a first instructing means instructs the command processing apparatus to perform preparation processing for receiving the command, and a second instructing means instructs the process requesting apparatus to directly send the command to the command processing apparatus in association with an instruction by the first instructing means.

When the process requesting apparatus does not satisfy the predetermined condition, sending of a command to the command processing apparatus, receiving of an execution result of the sent command from the command processing apparatus, and sending of the received execution result to the process requesting apparatus are performed. When the process requesting apparatus satisfies the predetermined condition, the command processing apparatus is instructed to perform preparation processing for receiving the command, and the process requesting apparatus is instructed to directly send the command to the command processing apparatus, and this makes it possible to directly send and receive the command and the execution result between the command processing apparatus and the process requesting apparatus. Thus, it is possible to surely mediate a data communication between the command processing apparatus and the process requesting apparatus, reducing the load.

A server according to an invention of claim 2 is dependent on claim 1, and the command processing apparatus receives the command through a router, and the preparation processing is processing for requesting the router to release an arbitrary port.

A server according to an invention of claim 3 is dependent on claim 2, and further comprises an acquiring means for acquiring an identifier of a port released in response to the instruction by the first instructing means from the command processing apparatus, and the second instructing means assigns destination information including the identifier acquired by the acquiring means to an instruction.

In a case that the command processing apparatus receives a command through a router, the router is made to release an arbitrary port through the command processing apparatus, an identifier of the released port is acquired from the command processing apparatus, and destination information including the identifier of the released port is notified to the process requesting apparatus. Thus, the process requesting apparatus can directly send the command to the command processing apparatus.

A server according to an invention of claim 4 is dependent on claim 1, and the predetermined condition includes a condition that a capability of the process requesting apparatus is higher than a threshold value, and the second sending means includes a reducing means for reducing a data amount included in the execution result depending on a capability of the process requesting apparatus.

When the capability of the process requesting apparatus is low, the data amount included in the received execution result is reduced depending on the capability of the process requesting apparatus, and therefore, even the process requesting apparatus with a low capability can utilize the execution result without laboring.

A server according to an invention of claim 5 is dependent on claim 4, and the capability includes a display capability, and the execution result includes image data, and the reducing means resizes the image data depending on the display capability. Thus, even the process requesting apparatus with a low capability can display an image without laboring.

A server according to an invention of claim 6 is dependent on claim 1, and the send request includes any one of a plurality of user identifiers, further comprises: a registering means for registering customer information including at least the plurality of user identifiers and service types respectively assigned to the plurality of user identifiers; an extracting means for extracting a user identifier from the send request before the determining means performs a determination; a specifying means for specifying a service type assigned to the user identifier extracted by the extracting means on the basis of the customer information, and a first invalidating means for invalidating the determining means, the first sending means, the receiving means and the second sending means when a specification result by the specifying means shows a first type, and the first instructing means performs an instruction when an invalidating by the first invalidating means is performed.

The send request includes any one of a plurality of user identifiers, and a registering means registers customer information including at least the plurality of user identifiers and service types respectively assigned to the plurality of user identifiers. Before the determining means performs a determination, an extracting means extracts a user identifier from the send request, and a specifying means specifies a service type assigned to the user identifier extracted by the extracting means on the basis of the customer information. When a specification result by the specifying means shows a first type, a first invalidating means invalidates the determining means, the first sending means, the receiving means and the second sending means. The first instructing means performs an instruction when an invalidating by the first invalidating means is performed.

If the service type assigned to the user identifier included in the send request is a first type, a command is sent to the command processing apparatus irrespective of whether or not the process requesting apparatus satisfies the predetermined condition, an execution result of the sent command is received from the command processing apparatus, and the received execution result is sent to the process requesting apparatus.

A server according to an invention of claim 7 is dependent on claim 6, and further comprises a second invalidating means for invalidating the first instructing means and the second instructing means when the specification result by the specifying means shows a second type, and the first sending means performs a sending when the invalidating by the second invalidating means is performed.

If the service type assigned to the user identifier included in the send request is a second type, the command processing apparatus is instructed to perform preparation processing for receiving the command irrespective of whether or not the process requesting apparatus satisfies the predetermined condition, and the process requesting apparatus is instructed to directly send the command to the command processing apparatus.

According to claims 6 and 7, it is possible to constantly perform a communication with a “via-the server”, and also constantly perform a communication with a “not-via-the server” at user's discretion.

A server according to an invention of claim 8 comprises: a data amount determining means for, when a send request for requesting to send a command to a command processing apparatus is accepted from a process requesting apparatus, determining whether or not a data amount included in an execution result of the command is above a first threshold value; a first sending means for sending the command to the command processing apparatus when a determination result by the data amount determining means is negative; a receiving means for receiving from the command processing apparatus an execution result of the command sent by the first sending means; a second sending means for sending the execution result received by the receiving means to the process requesting apparatus; a first instructing means for instructing the command processing apparatus to perform preparation processing for receiving the command when the determination result by the data amount determining means is affirmative; and a second instructing means for instructing the process requesting apparatus to directly send the command to the command processing apparatus in association with an instruction by the first instructing means.

A data amount determining means, when a send request for requesting to send a command to a command processing apparatus is accepted from a process requesting apparatus, determines whether or not a data amount included in an execution result of the command is above a first threshold value. When a determination result by the data amount determining means is negative, a first sending means sends the command to the command processing apparatus. A receiving means receives from the command processing apparatus an execution result of the command sent by the first sending means, and a second sending means sends the execution result received by the receiving means to the process requesting apparatus. When the determination result by the data amount determining means is affirmative, a first instructing means instructs the command processing apparatus to perform preparation processing for receiving the command, and a second instructing means instructs the process requesting apparatus to directly send the command to the command processing apparatus in association with an instruction by the first instructing means.

When the data amount included in the execution result of the command is below a threshold value, sending of a command to the command processing apparatus, receiving of an execution result of the sent command from the command processing apparatus, and sending of the received execution result to the process requesting apparatus are performed. When the data amount included in the execution result of the command is above the threshold value, the command processing apparatus is instructed to perform preparation processing for receiving the command, and the process requesting apparatus is instructed to directly send the command to the command processing, and this makes it possible to directly send and receive the command and the execution result between the command processing apparatus and the process requesting apparatus. Thus, it is possible to surely mediate a data communication between the command processing apparatus and the process requesting apparatus, reducing the load.

A server according to an invention of claim 9 is dependent on claim 8, and further comprises: a load determining means for determining whether or not a load is below a second threshold value before the data amount determining means performs a determination; and a first invalidating for invalidating the data amount determining means when a determination result by the load determining means is affirmative, and the first sending means perform a sending when the determination result by the load determining means is affirmative.

A load determining means determines whether or not a load is below a second threshold value before the data amount determining means performs a determination. A first invalidating means invalidates the data amount determining means when a determination result by the load determining means is affirmative. A first sending means performs a sending when the determination result by the load determining means is affirmative.

When it is determined that a load is below the threshold value, the data amount determining means is invalidated, thus neither of the instruction by the first instructing means and the instruction by the second instructing means are performed. Meanwhile, the first sending means performs a sending, and a receiving by the receiving means and a sending by the second sending means are accordingly performed.

When a load is light, a communication is performed with a “via-the server” irrespective of the size of the data amount, capable of processing necessary for the execution result.

A server according to an invention of claim 10 is dependent on claim 9, and further comprises: a charge determining means for determining whether or not processing according to the command is an object to be charged before the load determining means performs a determination; and a second invalidating means for invalidating the data amount determining means and the load determining means when a determination result by the charge determining means is affirmative, and the first instructing means performs an instructing when the determination result by the charge determining means is affirmative.

A charge determining means determines whether or not processing according to the command is an object to be charged before the load determining means performs a determination. A second invalidating means invalidates the data amount determining means and the load determining means when a determination result by the charge determining means is affirmative. The first sending means performs a sending when the determination result by the charge determining means is affirmative.

When it is determined that the processing according to the command is an object to be charged, both of the data amount determining means and the load determining means are invalidated, and therefore, both of the instruction by the first instructing means and the instruction by the second instructing means are not performed. Meanwhile, the first sending means performs a sending, and a receiving by the receiving means and a sending by the second sending means are accordingly performed.

If the processing according to the command is an object to be charged, a communication is performed with a “via-the server” irrespective of a magnitude of the load and the size of the data amount, capable of surely performing a charge.

A mediating method according to an invention of claim 11 is a meditating method mediating a data communication between a command processing apparatus and a process requesting apparatus, and comprises: a determining step for, when a send request for requesting to send a command to a command processing apparatus is accepted from a process requesting apparatus, determining whether or not the process requesting apparatus satisfies a predetermined condition; a first sending step for sending the command to the command processing apparatus when a determination result by the determining step is negative; a receiving step for receiving from the command processing apparatus an execution result of the command sent by the first sending step; a second sending step for sending the execution result received by the receiving step to the process requesting apparatus; a first instructing step for instructing the command processing apparatus to perform preparation processing for receiving the command when the determination result by the determining step is affirmative; and a second instructing step for instructing the process requesting apparatus to directly send the command to the command processing apparatus in association with an instruction by the first instructing step.

A control program according to an invention of claim 12 is a control program to be executed by a processor of a server mediating a data communication between a command processing apparatus and a process requesting apparatus, and comprises: a determining step for, when a send request for requesting to send a command to a command processing apparatus is accepted from a process requesting apparatus, determining whether or not the process requesting apparatus satisfies a predetermined condition; a first sending step for sending the command to the command processing apparatus when a determination result by the determining step is negative; a receiving step for receiving from the command processing apparatus an execution result of the command sent by the first sending step; a second sending step for sending the execution result received by the receiving step to the process requesting apparatus; a first instructing step for instructing the command processing apparatus to perform preparation processing for receiving the command when the determination result by the determining step is affirmative; and a second instructing step for instructing the process requesting apparatus to directly send the command to the command processing apparatus in association with an instruction by the first instructing step.

A recording medium according to claim 13 records the control program shown in claim 12.

A mediating method according to an invention of claim 14 is a meditating method mediating a data communication between a command processing apparatus and a process requesting apparatus, and comprises: a data amount determining step for, when a send request for requesting to send a command to a command processing apparatus is accepted from a process requesting apparatus, determining whether or not a data amount included in an execution result of the command is above a first threshold value; a first sending step for sending the command to the command processing apparatus when a determination result by the data amount determining step is negative; a receiving step for receiving from the command processing apparatus an execution result of the command sent by the first sending step; a second sending step for sending the execution result received by the receiving step to the process requesting apparatus; a first instructing step for instructing the command processing apparatus to perform preparation processing for receiving the command when the determination result by the data amount determining step is affirmative; and a second instructing step for instructing the process requesting apparatus to directly send the command to the command processing apparatus in association with an instruction by the first instructing step.

A control program according to an invention of claim 15 is a control program to be executed by a processor of a server mediating a data communication between a command processing apparatus and a process requesting apparatus, and comprises: a data amount determining step for, when a send request for requesting to send a command to a command processing apparatus is accepted from a process requesting apparatus, determining whether or not a data amount included in an execution result of the command is above a first threshold value; a first sending step for sending the command to the command processing apparatus when a determination result by the data amount determining step is negative; a receiving step for receiving from the command processing apparatus an execution result of the command sent by the first sending step; a second sending step for sending the execution result received by the receiving step to the process requesting apparatus; a first instructing step for instructing the command processing apparatus to perform preparation processing for receiving the command when the determination result by the data amount determining step is affirmative; and a second instructing step for instructing the process requesting apparatus to directly send the command to the command processing apparatus in association with an instruction by the first instructing step.

A recording medium according to claim 16 records control program shown in the claim 15.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of one embodiment of the present invention;

FIG. 2 is an illustrative view showing a customer information database;

FIG. 3 is an illustrative view showing a terminal information database;

FIG. 4 is an illustrative view showing a client information database;

FIG. 5 (A) is a sequence diagram showing a communication system according to a “via-the server” system;

FIG. 5 (B) is an illustrative view showing a configuration of an access packet;

FIG. 6 (A) is a sequence diagram showing a communication system according to a “not-via-the server” system;

FIG. 6 (B) is an illustrative view showing a configuration of an access packet;

FIG. 6 (C) is an illustrative view showing a configuration of a port notification packet;

FIG. 6 (D) is an illustrative view showing a configuration of a redirect instruction packet;

FIG. 7 is a flowchart showing a part of an operation of a server CPU;

FIG. 8 is a flowchart showing another part of the operation of the server CPU;

FIG. 9 is a flowchart showing the other part of the operation of the server CPU;

FIG. 10 is a flowchart showing a part of an operation of a client CPU;

FIG. 11 is a flowchart a part of an operation of a server CPU in other embodiment; and

FIG. 12 is a flowchart showing another part of the operation of the server CPU in the other embodiment.

### BEST MODE FOR PRACTICING THE INVENTION

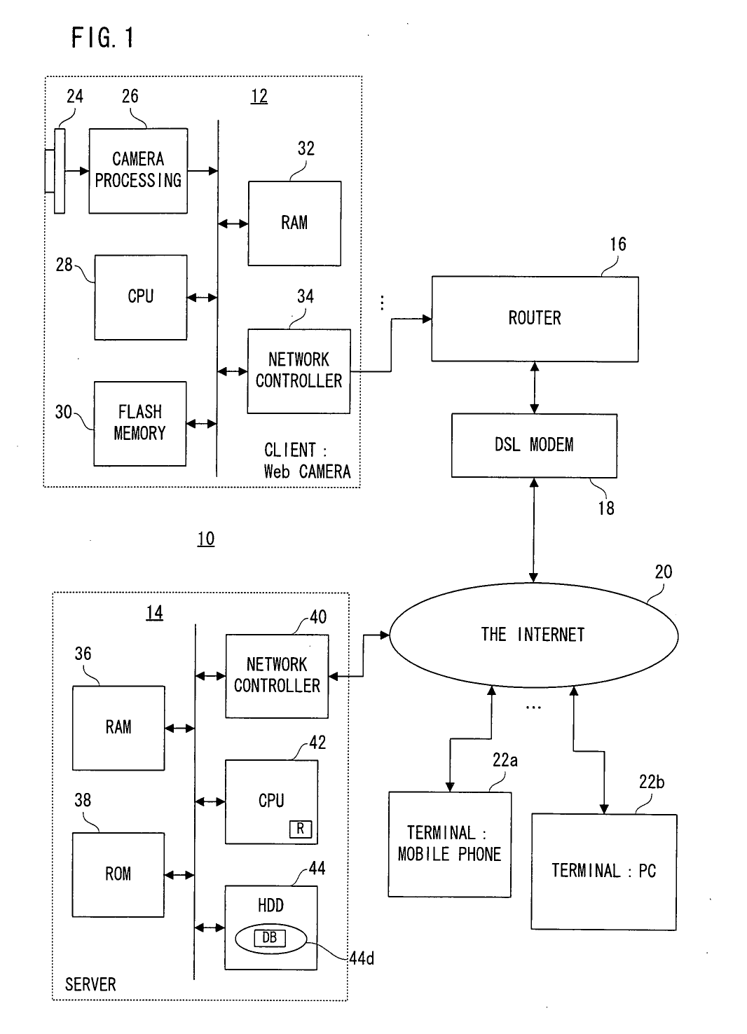

Referring to FIG. 1, a surveillance camera system 10 of this embodiment includes a Web camera 12 as a client and a server 14. The server 14 is connected to the Internet 20 via a leased line not shown, and the Web camera 12 is also connected to the Internet 20 via a router 16 and a DSL modem 18.

It should be noted that the router 16 is connected with other client like home information appliances like a PC as needed as well as the Web camera 12. As a router 16, a type compliant with a UPnP (Universal Plug & Play) protocol is utilized. The router of this type has a function of releasing a desired port in accordance with a client's request.

The Internet 20 is further connected with various terminals, such as a mobile phone 22a and a personal computer (PC) 22b in this embodiment via a gateway, a modem, or the like not shown.

The Web camera 12 directly accepts an operation from the mobile phone 22a and the PC 22b through the server 14 or not through the server 14. The detailed operation includes an operation of adjusting a sensitivity, a zoom magnification, etc. through an imager 24 and a camera processing circuit 26, and controlling a direction of the Web camera 12 via a drive unit not shown.

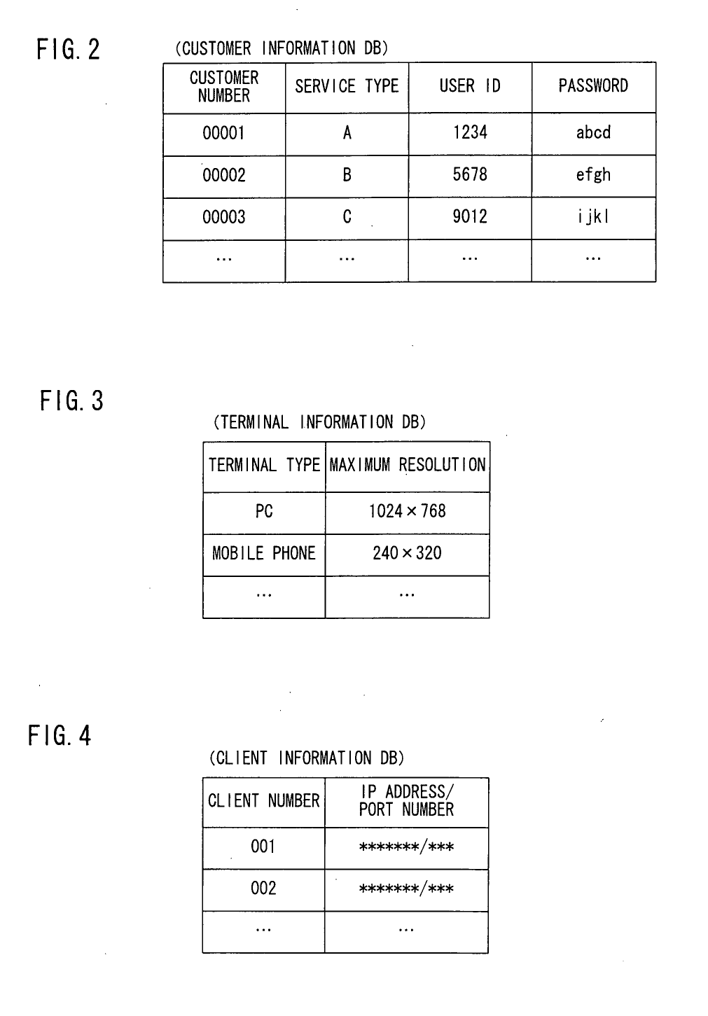

A hard disk 44d of the server 14 stores databases (DB), and the server 14 executes processing such as authentication, allocation, intermediate, and etc. on the basis of the DB. The DB specifically includes a customer information DB shown in FIG. 2, a terminal information DB shown in FIG. 3, and a client information DB shown in FIG. 4.

With reference to FIG. 2, in the customer information DB, a service type, a user ID and a password as to each of users registered as a customer is registered one by one. A user utilizing the service A is always adopted a “not-via-the server” system as a system executing a communication between the terminal and the client. A user utilizing the service B is adopted a “via-the server” system when making access from the mobile phone 22a, and is adopted the “not-via-the server” system when making access from the PC 22b. A user utilizing the service C is always adopted the “via-the server” system. The user ID and the password are utilized in authentication processing for determining whether or not a user making access to the server 14 is an authenticated user.

Referring to FIG. 3, in the terminal information DB, as to various terminals utilized by users, a parameter representative of a capability like a display capability, that is, a maximum resolution of a monitor screen in this embodiment is registered. When an execution result received from the client is sent to a terminal, the maximum resolution is utilized for performing resize processing to make the size of the image included in the execution result conform to the size of the terminal screen.

Additionally, in the terminal information DB, a communication speed, a processing speed, a storage capacity, etc. may be registered in place of or along with the maximum resolution. That is, in the terminal information DB, one or plurality of parameters representative of a capability of a terminal are registered. The server 14 executes optimization processing for optimizing an execution result for an individual terminal on the basis of the registered one or plurality of parameters. As a specific example of the optimization processing, conversion of frame rates, changes of compression rates, etc. are enumerated in addition to the resize processing.

With reference to FIG. 4, in the client information DB, an IP address and a port number are registered as to the clients connected to the router 16 one by one. If the “via-the server” is selected as a communication system between the client and the terminal, the server 14 sends a command received from a terminal to a client on the basis of an IP address and a port number registered in the client information DB.

On the other hand, if the “not-via-the server” is selected as a communication system, the server 14 instructs a client to issue a port releasing request for requesting the router 16 to release an arbitrary port, acquires the number of the released port from the client, and notifies the acquired released port number and the IP address registered in the client information DB to a terminal. The terminal sends a command to the destination specified by the notified address and port number.

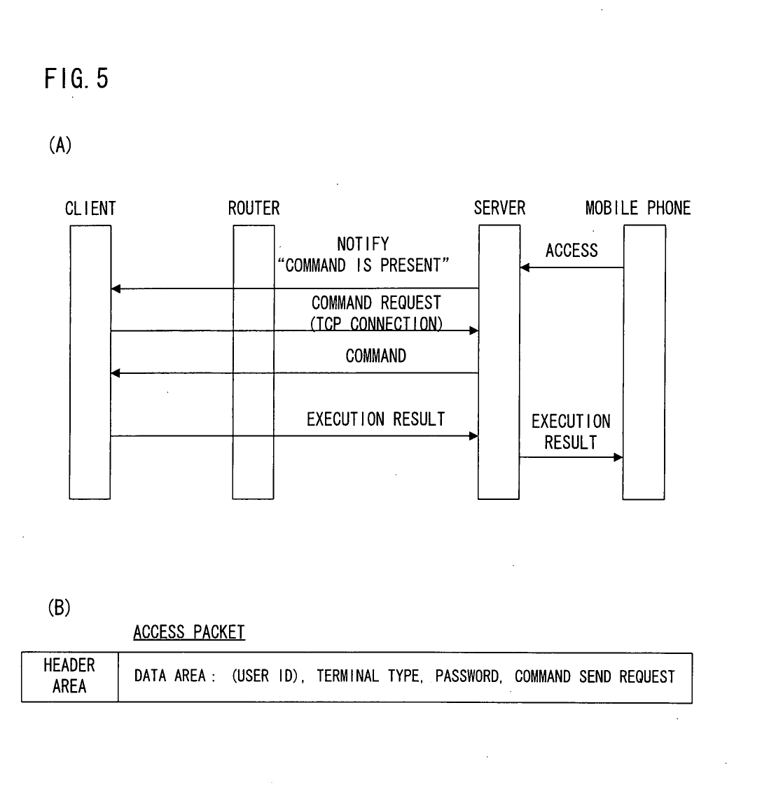

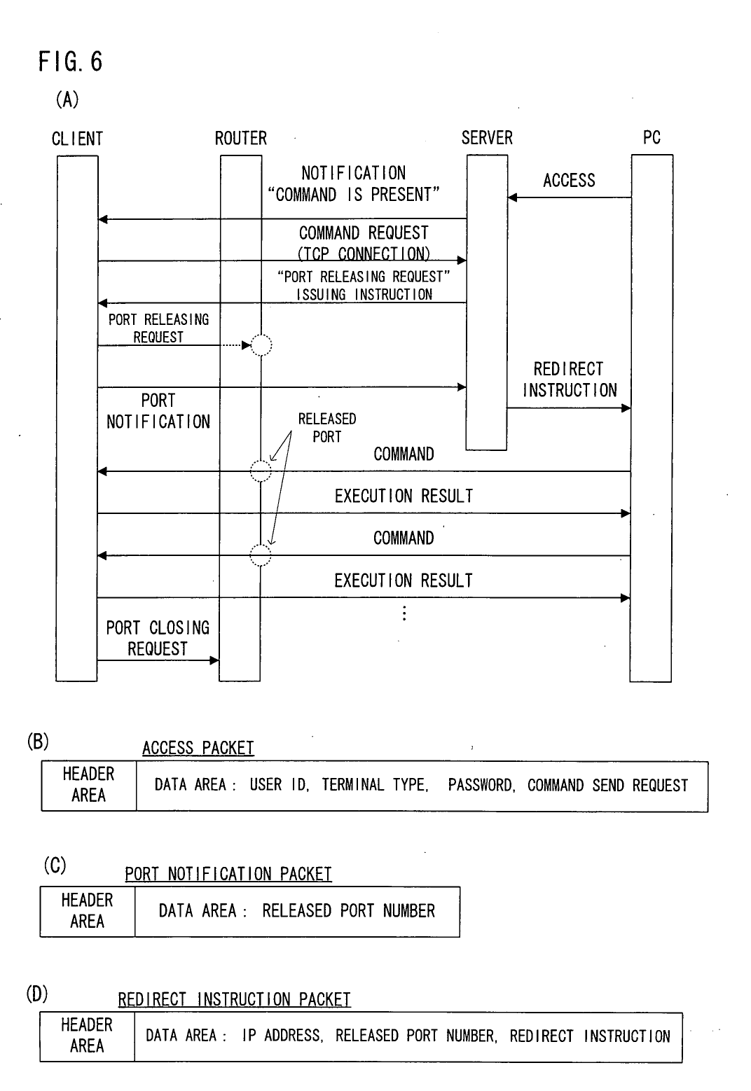

FIG. 5 (A) shows a communication protocol according to the “via-the server” system, and FIG. 6 (A) shows a communication protocol according to the “not-via-the server” system. Here, the “service B” is assigned to a user, and thus, when the user accesses the server 14 from the mobile phone 22a, the “via-the server” system is selected, and when the user accesses it from the PC 22b, the “not-via-the server” system is selected.

First, referring to FIG. 5 (A), an access packet sent from the mobile phone 22a is received by the server 14. In the data area of the access packet, a user ID, a terminal type, a password and a command send request are stored as shown in FIG. 5 (B). Additionally, in a case of a terminal like the mobile phone 22a only utilized by a specific user, if an appliance ID described in the header area is utilized as a user ID, the user ID can be omitted from the data area. That is, the user can save himself or herself some work of inputting his or her own ID to the terminal at a time of making access.

The server 14 extracts information such as the user ID, the terminal type, the password and the command send request from the received access packet, and holds the extracted information in the RAM 36. It should be noted that the information in the RAM 36 is backed up in the hard disk drive (HDD) 44 (and so forth) at any time. Then, the client is notified that “a command is present” on the basis of the IP address and port number described in the client information DB (see FIG. 4).

After notification, the server 14 searches the customer information DB (see FIG. 2) by taking the extracted user ID as a key to specify a service type, and determine a communication system on the basis of the specified service type and the extracted terminal type. In this case, the service type is “B”, and the terminal type is a “mobile phone”, so that the communication system is determined to be the “via-the server”.

The client (Web camera 12) which has received the notification establishes a TCP (Transmission Control Protocol) connection with the server 14, and then requests a command to the server 14. Since the communication system is the “via-the server”, the requested server 14 sends a command according to the send request stored in the RAM 36 to the client.

The client executes processing according to the command, and sends an execution result to the server 14. The server 14 receives the execution result, and sends the received execution result to the mobile phone 22a. At this time, the server 14 determines whether or not an image size included in the execution result conforms to the resolution of the monitor screen (not illustrated) of the mobile phone 22a by consulting the terminal information DB (see FIG. 3), and if it does not conform, resize processing is performed on the image. The mobile phone 22a receives the sent execution result, and displays the received execution result on the monitor screen.

Referring to FIG. 6 (A), an access packet sent from the PC 22b is received by the server 14. In the data area of the access packet, a user ID, a terminal type, a password and a command send request are stored as shown in FIG. 6 (B).

The server 14 extracts information from the received access packet, holds the extracted information in the RAM 36, and notifies the client that “a command is present”. After notification, the server 14 specifies the service type, and determines the communication system. In this case, the service type is “B”, and the terminal type is the “PC”, so that the communication system is determined to be the “not-via-the server”.

The client that has received a notification that “a command is present” requests a command from the server 14. Since the communication system is the “not-via-the server”, the server 14 that has received the request instructs the client to issue a “port releasing request” in place of sending the command. The client that has been instructed to issue a “port releasing request” requests the router 16 to release an arbitrary port. The router 16 releases a port according to the request. Then, the client sends a port notification packet to the server 14. In the data area of the port notification packet, a number of the released port is described as shown in FIG. 6 (C).

The server 14 receives the port notification packet, and sends a redirect instruction packet to the PC 22b. In the data area of the redirect instruction packet, an IP address of the client, the released port number extracted from the port notification packet, and the redirect instruction are described as shown in FIG. 6 (D). It should be noted that the IP address is read from the client information DB (see FIG. 4).

The PC 22b receives the redirect instruction packet, and sends a command to the client. The sending of the command is performed so as to be directed to a destination specified by the extracted IP address and the port number extracted from the redirect instruction packet.

The client executes the processing according to the command, and then sends an execution result to the PC 22b. The PC 22b receives the sent execution result, and displays an image on the basis of the received execution result on the monitor screen (not illustrated). Until the released port is closed from that time, the PC 22b can directly send a command to the client, and directly receive an execution result from the client.

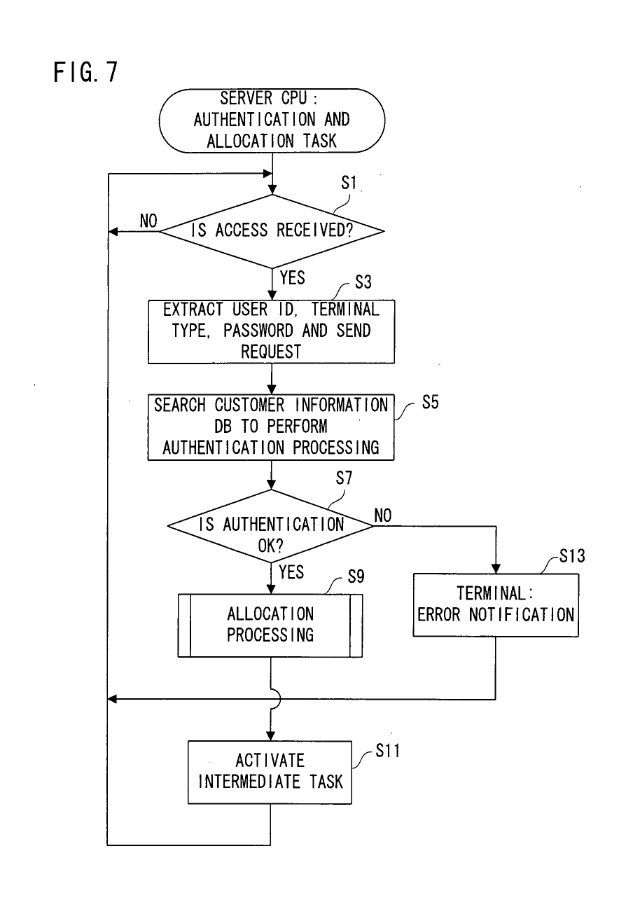

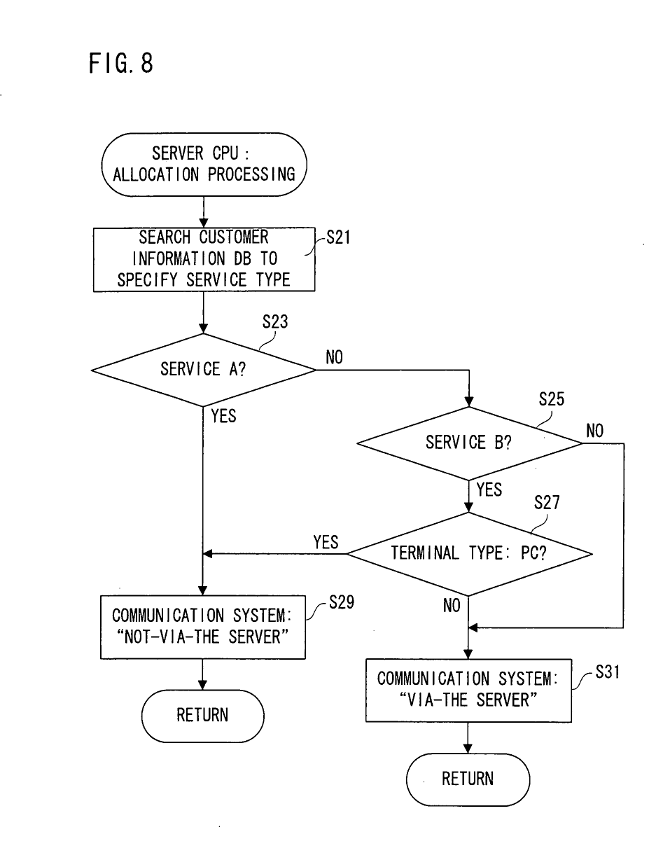

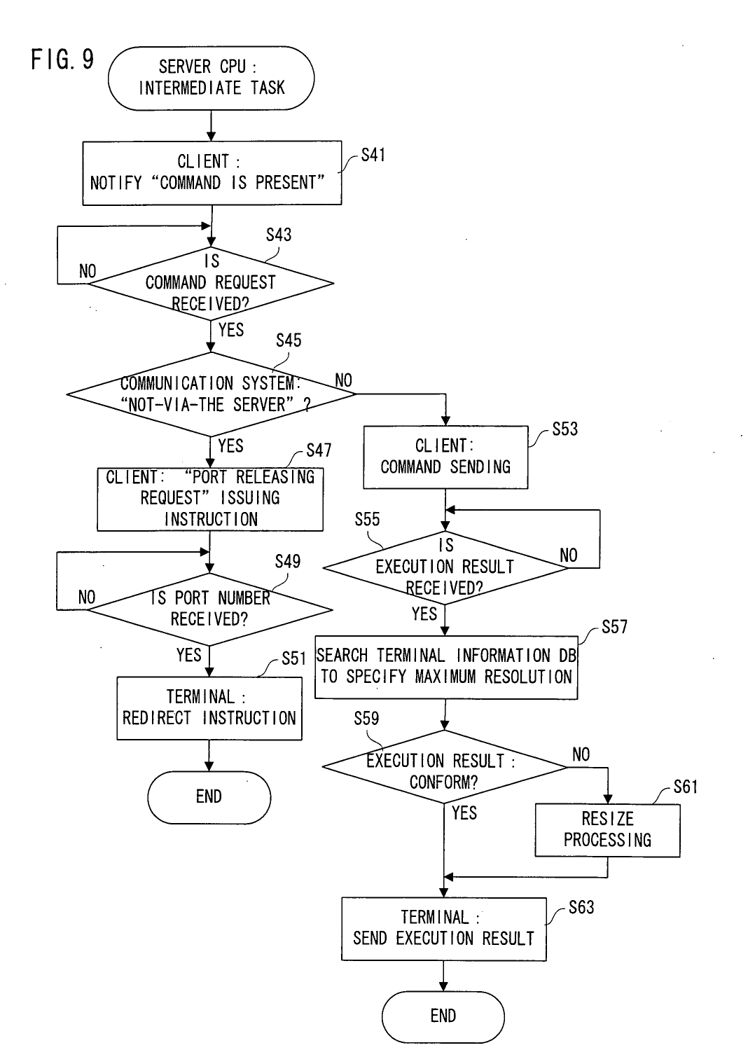

The CPU 42 of the server 14 specifically executes an authentication and allocation task shown in FIG. 7 and FIG. 8 and an intermediate task shown in FIG. 9. The authentication and allocation task is constantly activated, the CPU 42 executes authentication according to the authentication and allocation task when accepting access from the terminal, and executes allocation processing when the authentication is established. The intermediate task is activated after completion of the allocation processing. When the authentication and allocation task and the intermediate task are activated, the CPU 42 executes the two tasks in a parallel manner under the control of the multitasking OS such as CITRON. Additionally, control programs in correspondence to these flowcharts are stored in the ROM 38.

Referring to FIG. 7, in a step S1, the CPU 42 determines whether or not an access packet (see FIG. 5 (B), FIG. 6 (B)) is received through a network controller 40. When an access packet is received, the process shifts to a step S3 to extract an user ID, a terminal type, a password and a command send request from the access packet. The extracted information is held in the RAM 36.

In a step S5, the customer information DB (see FIG. 2) is searched to execute authentication processing based on the user ID and the password. In a step S7, it is determined whether or not authentication is established. More specifically, it is determined whether or not the user ID and the password extracted from the access packet match the registered information of the customer information DB, and if they match, the authentication is established. If the authentication is not established, an error is notified to the terminal in a step S13, and then, the process returns to the step S1.

If the authentication is established, the process shifts to a step S9 from the step S7 to execute allocation processing (described later). After the completion of the allocation processing, in a step S11, an intermediate task is activated, and then, the process returns to the step S1.

The allocation processing in the step S9 is according to a subroutine shown in FIG. 8. With reference to FIG. 8, the CPU 42 searches the customer information DB (see FIG. 2) to specify the service type in a step S21. More specifically, a service type corresponding to the user ID extracted in the step S3 is read from the customer information DB.

In steps S23 and S25, it is determined that the read service type is “A”, “B” or “C”. If the service type is “A”, the process shifts from the step S23 to a step S29 to determine that the communication system is the “not-via-the server”. If the service type is “B”, the process shifts to a step S27 from the step S25. If the service type is “C”, the process shifts from the step S25 to a step S31 to determine that the communication system is the “via-the server”.

In the step S27, it is determined whether or not the read terminal type is a PC, and if the determination result is affirmative, the process shifts to the step S29 to determine that the communication system is the “not-via-the server”. If the determination result is negative, the process shifts to the step S31 to determine that the communication system is the “via-the server”.

That is, if the service type is “A”, the communication system is determined to be the “not-via-the server” regardless of the terminal type, and if the service type is “C”, the communication system is determined to be the “via-the server” regardless of the terminal type. In a case that the service type is “B”, if the terminal type is a PC, the communication system is determined to be the “not-via-the server”, and if the terminal type is a mobile phone, the communication system is determined to be the “via-the server”.

The information representative of the communication system thus determined is held in a register R within the CPU 42. After completion of the determination, the CPU 42 is restored to the hierarchical upper level of the routine.

With reference to FIG. 9, when the intermediate task is activated, the CPU 42 notifies the client that “a command is present” in a step S41, and waits for a command request from the client in a step S43. When the command request is received through the network controller 40, the process shifts to a step S45 to determine whether or not the communication system is the “not-via-the server”. The determination is made with reference to the register R. If the determination result is affirmative, steps S47-S51 are executed, and if negative, steps S53-S63 are executed.

In the step S47, the client is instructed to issue a “port releasing request”. In the step S49, a port notification packet (see FIG. 6 (C)) to be sent from the client is waited. When the port notification packet is received, a redirect instruction packet (see FIG. 6 (D)) is sent to the terminal in the step S51. After completion of sending the redirect instruction packet, the task is ended.

In the step S53, a command is sent to the client. In the step S55, an execution result to be sent from the client is waited. When the execution result is received, the process shifts to the step S57 to specify a maximum resolution of the terminal by searching the terminal information DB (see FIG. 3). More specifically, the maximum resolution in correspondence to the terminal type extracted in the step S3 is read from the terminal information DB. In the step S59, it is confirmed that a size of the image included in the received execution result does not exceed the specified maximum resolution.

If the image size is within the maximum resolution, the process proceeds to the step S63. If the image size exceeds the maximum resolution, resize processing is performed in the step S61, and then, the process shifts to the step S63. In the step S63, the execution result is sent to the terminal. After sending of the execution result, the task is completed.

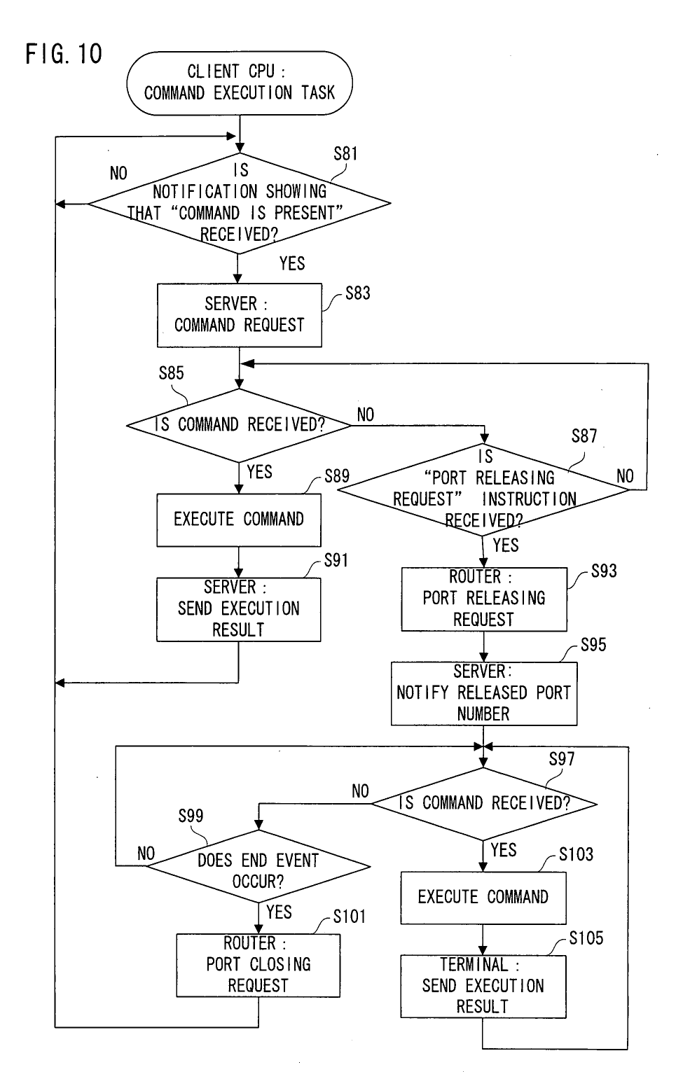

The CPU 28 of the client (Web camera 12) specifically executes processing according to the command execution task shown in FIG. 10. The command execution task is activated when a remote control mode is turned on via an operation panel not shown, and ended when the remote control mode is turned off. The CPU 28 receives a command via the server or not via the server from the terminal according to the task, executes processing according to the command, and sends the execution result to the terminal via the server or not via the server. When a plurality of tasks including the command execution task are activated, the CPU 28 executes the plurality of tasks in a parallel manner under the control of the multitasking OS such as CITRON. Additionally, control programs in correspondence to these flowcharts are stored in a flash memory 30.

Referring to FIG. 10, in a step S81, the CPU 28 determines whether or not a notification showing that “a command is present” is received from the server 14. If the notification is received, the process shifts to a step S83 to request a command from the server 14. Thereafter, the process enters a loop of steps S85 and S87. In the step S85, it is determined whether or not a command from the server 14 is received, and in the step S87, it is determined whether or not an issuing instruction of a “port releasing request” is received.

If a command from the server 14 is received, “YES” is determined in the step S85, and the process shifts to a step S89 to execute the processing according to the command. In a next step S91, the execution result is sent to the server 14, and then, the process returns to the step S81.

When an issuing instruction of a “port releasing request” is received, “YES” is determined in the step S87, and the process shifts to a step S93 to request the router 16 to release an arbitrary port. In a step S95, the number of the released port is notified to the server 14. Thereafter, the process enters a loop of steps S97 and S99. In the step S97, it is determined whether or not a command from the terminal is received, and in the step S99, it is determined whether or not an end event occurs.

When a command from the terminal is received, “YES” is determined in the step S97, and the process shifts to a step S103 to execute processing according to the command. In a next step S105, an execution result is sent to the terminal, and then, the process enters a loop of the steps S97 and S99. When an end event occurs, the router 16 is requested to close the released port, and then, the process returns to the step S81. It should be noted that the end event includes receiving an end notification from the terminal or the server 14, detection of time-out, etc.

As understood from the above description, when accepting an access from the terminal (mobile phone 22a, PC 22b), the server 14 in this embodiment selects any one of the “via-the server” system and the “not-via-the server” system on the basis of the type of the service assigned to the user of the terminal and the type of the terminal, that is, a capability of the terminal.

More specifically, if the service type is “A”, the “not-via-the server” is selected regardless of the type of the terminal, and if the service type is “C”, the “via-the server” is selected regardless of the type of the terminal. If the service type is “B”, determination of the terminal type is performed, and when the determination result shows a mobile phone 22a, the “via-the server” is selected. If the determination result shows a PC 22b, the “not-via-the server” is selected.

That is, with respect to an access from the PC 22b having a high capability of a display, information processing, a communication, etc. the “not-via-the server” is selected, and with respect to an access from the mobile phone 22a having a low capability, the “via-the server” is selected. Depending on the user's discretion, such an automatic selection based on the capability of the terminal is not performed, and in any of an access from the PC 22b and an access from the mobile phone 22a, the “via-the server” can be set to constantly be selected, and the “not-via-the server” can be set to constantly be selected.

When the “via-the server” system is selected, the server 14 sends a command to the client (Web camera 12), receives an execution result of the processing according to the command from the client, and sends the received execution result to the terminal.

When the “not-via-the server” system is selected, the server 14 first instructs the client to perform preparation processing for receiving a command. Specifically, the client is instructed to issue a port releasing request for requesting the router 16 to release an arbitrary port. Next, a number of the released port is acquired from the client, and the terminal is instructed to send a command to the destination specified by the destination information including the acquired number.

If the “via-the server” system is selected, it is possible to perform an optimization of the execution result for the terminal. On the other hand, if the not-via-the server” system is selected, it is possible to reduce a load.

Either of such two communication systems is automatically selected on the basis of the capability of the terminal, and therefore, the terminal can easily utilize the execution result without a bother operation by the user. More specifically, when an access is made from the mobile phone 22a with a low display capability, the “via-the server” is automatically selected to allow the server 14 to resize the image included in the execution result. Thus, the mobile phone 22a can display the image on the entire monitor screen without the user performing a scrolling operation.

Furthermore, in the server 14 of this embodiment, any one of the “via-the server” system and the “not-via-the server” system is selected on the basis of the capability of the terminal, but selection of the communication system may be performed on the basis of the data amount, a magnitude of load, whether or not charging is performed, etc. included in the execution result of the command. In what follows, another embodiment making the selection with such a reference is described.

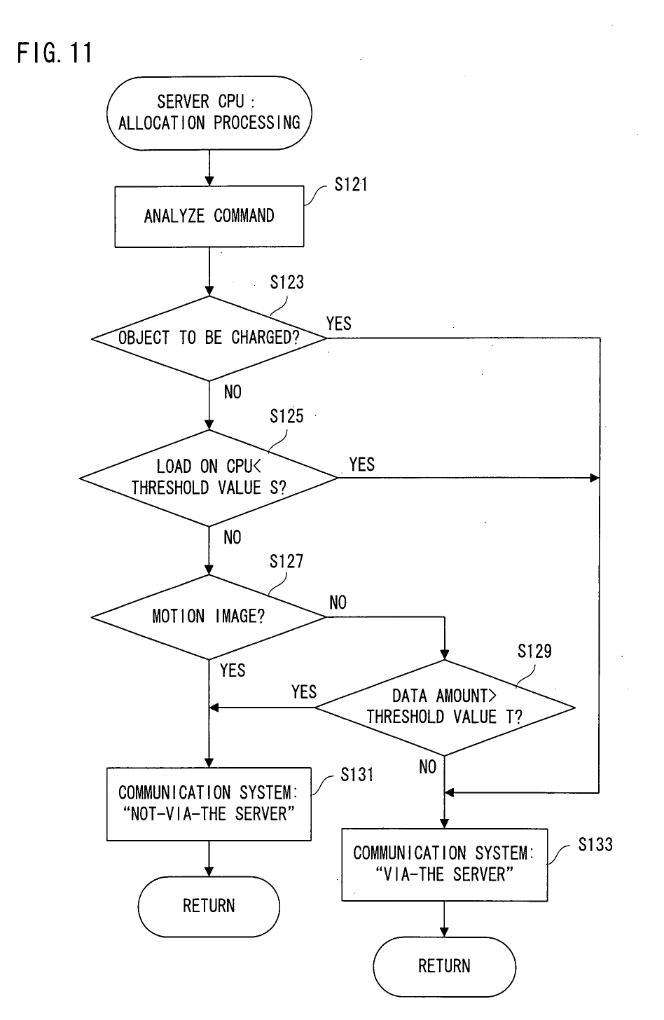

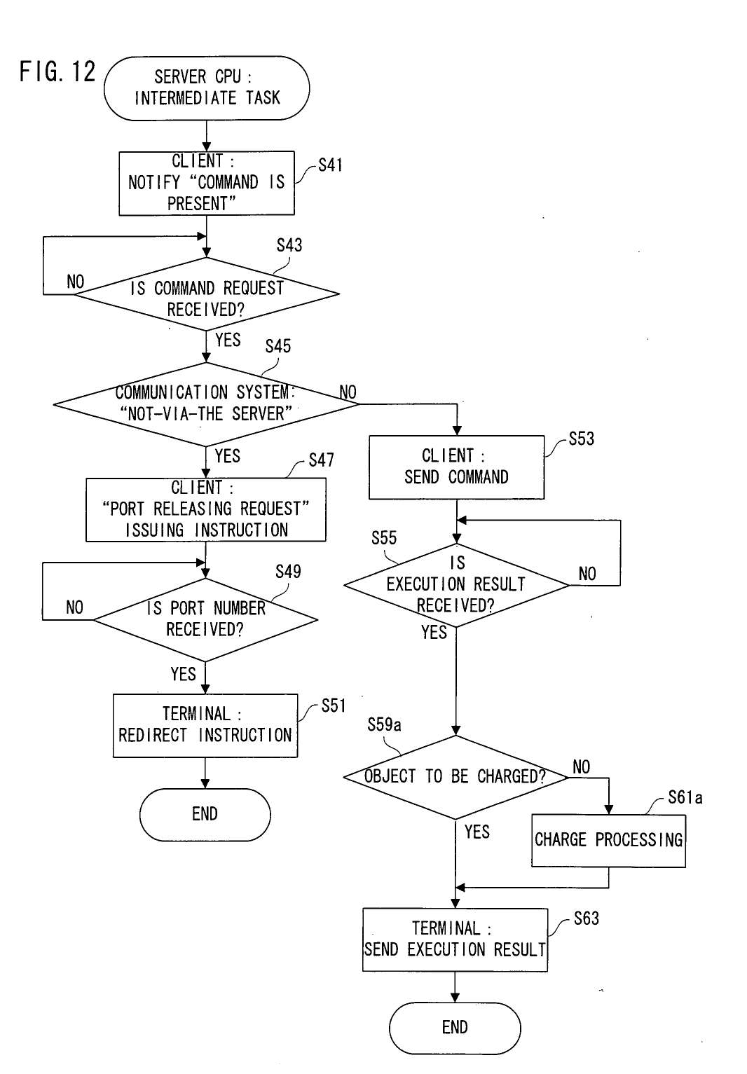

This embodiment is different from the previous embodiment in only the allocation processing and a part of the intermediate task. Thus, FIG. 1-FIG. 7 and FIG. 10 are employed also in this embodiment, and an overlapped explanation will be omitted. The allocation processing shown in the step S9 in FIG. 7 is according to a subroutine in FIG. 11. In a similar manner, the intermediate task shown in the step S11 is executed according to the flowchart shown in FIG. 12.

With reference to FIG. 11, in a step S121, the CPU 42 analyzes a command send request extracted from the access packet (see FIG. 5 (B), FIG. 6 (B)). In a step S123, it is determined whether or not the processing according to the command is an object to be charged. If it is an object to be charged, the process proceeds to a step S133 and determines that the communication system is the “via-the server”.

If it is not an object to be charged, the process shifts to a step S125 to determine whether or not the current load of the CPU 42 of its own is below a threshold value S. If the load is below the threshold value S, the process proceeds to the step S133 and determines that the communication system is the “via-the server”. If the load reaches the threshold value S, the process shifts to a step S127 to determine whether or not a motion image is included in the execution result of the command. If a motion image is included in the execution result, the process proceeds to a step S131, and determines that the communication system is the “not-via-the server”.

If a motion image is not included in the execution result, the process shifts to a step S129 to further determine a data amount included in the execution result is above a threshold value T. If the data amount is above the threshold value T, the process proceeds to the step S131, and determines that the communication system is the “not-via-the server”. If the data amount is below the threshold value T, the process proceeds to the step S133, and determines that the communication system is the “via-the server”.

That is, if the processing according to the command is an object to be charged, the “via-the server” system is selected irrespective of the load and the data amount. If the processing according to the command is not an object to be charged, when the load imposed on the CPU 42 is light, the “via-the server” system is selected. When the load imposed on the CPU 42 is heavy, in a case that a motion image is included in the execution result, or the data amount of the execution result is large, the “not-via-the server” system is selected, and in a case that a motion image is not included in the execution result, and the data amount of the execution result is small, the “via-the server” system is selected.

The information representative of the communication system thus determined is held in the register R within the CPU 42. After determination, the CPU 42 is restored to the hierarchical upper level of the routine.

Referring to FIG. 12, steps S41-S55 are the same as the steps S41-S55 in FIG. 9. When the determination result in the step S55 is affirmative, the CPU 42 shifts to a step S59a. In the step S59a, it is determined whether or not the processing according to the sent command is an object to be charged. If the determination result is affirmative, charge processing is performed in a step S61a, and then, the process shifts to a step S63. Here, the charge is made with respect to the customer in correspondence to the user ID extracted in the step S3 (see FIG. 7).

When the determination result is negative in the step S59a, the process directly shifts to the step S63. In the step S63, an execution result is sent to the terminal. After sending the execution result, the task is ended.

In this embodiment, if the processing according to the command is an object to be charged, the server 14 selects the “via-the server” as a communication system, and performs charging processing when sending the execution result received from the client (Web camera 12) to the terminal (mobile phone 22a, PC 22b). If the processing according to the command is not an object to be charged, when the load of the CPU 42 is light, the “via-the server” system is selected. When the load of the CPU 42 is heavy, in a case that a motion image is included in the execution result, or in a case that the data amount of the execution result is large, the “not-via-the server” system is selected, and in a case that a motion image is not included in the execution result, and the data amount of the execution result is small, the “via-the server” system is selected.

If the processing according to the command is an object to be charged, the “via-the server” system is selected to thereby surely make a charge. If it is not an object to be charged, at a time of a heavy load on the CPU 42, the “via-the server” system is selected as necessary depending on the manner of the data and the data amount included in the execution result to thereby reduce the load imposed on the CPU 42.

In the above description, the surveillance camera system 10 including the Web camera 12 and the server 14 is explained, but the present invention can be applied to any processing systems including a server and a command processing apparatus (client) which executes processing according to a command notified from the server.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A server, comprising:
a determining means for, when a send request for requesting to send a command to a command processing apparatus is accepted from a process requesting apparatus, determining whether or not said process requesting apparatus satisfies a predetermined condition;
a first sending means for sending said command to said command processing apparatus when a determination result by said determining means is negative;
a receiving means for receiving from said command processing apparatus an execution result of said command sent by said first sending means;
a second sending means for sending the execution result received by said receiving means to said process requesting apparatus;
a first instructing means for instructing said command processing apparatus to perform preparation processing for receiving said command when the determination result by said determining means is affirmative; and
a second instructing means for instructing said process requesting apparatus to directly send said command to said command processing apparatus in association with an instruction by said first instructing means.

2. A server according to claim 1, wherein said command processing apparatus receives said command through a router, and said preparation processing is processing for requesting said router to release an arbitrary port.

3. A server according to claim 2, further comprising an acquiring means for acquiring an identifier of a port released in response to the instruction by said first instructing means from said command processing apparatus, wherein said second instructing means assigns destination information including the identifier acquired by said acquiring means to an instruction.

4. A server according to claim 1, wherein said predetermined condition includes a condition that a capability of said process requesting apparatus is higher than a threshold value, and said second sending means includes a reducing means for reducing a data amount included in said execution result depending on a capability of said process requesting apparatus.

5. A server according to claim 4, wherein said capability includes a display capability, said execution result includes image data, and said conforming means resizes said image data depending on said display capability.

6. A server according to claim 1, wherein
said send request includes any one of a plurality of user identifiers, further comprising:
a registering means for registering customer information including at least said plurality of user identifiers and service types respectively assigned to said plurality of user identifiers; an extracting means for extracting a user identifier from said send request before said determining means performs a determination; a specifying means for specifying a service type assigned to the user identifier extracted by said extracting means on the basis of said customer information; and a first invalidating means for invalidating said determining means, said first sending means, said receiving means and said second sending means when a specification result by said specifying means shows a first type, wherein
said first instructing means performs an instruction when an invalidating by said first invalidating means is performed.

7. A server according to claim 6, further comprising a second invalidating means for invalidating said first instructing means and said second instructing means when the specification result by said specifying means shows a second type, and said first sending means performs a sending when the invalidating by said second invalidating means is performed.

8. A server, comprising:
a data amount determining means for, when a send request for requesting to send a command to a command processing apparatus is accepted from a process requesting apparatus, determining whether or not a data amount included in an execution result of said command is above a first threshold value;
a first sending means for sending said command to said command processing apparatus when a determination result by said data amount determining means is negative;
a receiving means for receiving from said command processing apparatus an execution result of said command sent by said first sending means;
a second sending means for sending the execution result received by said receiving means to said process requesting apparatus;
a first instructing means for instructing said command processing apparatus to perform preparation processing for receiving said command when the determination result by said data amount determining means is affirmative; and
a second instructing means for instructing said process requesting apparatus to directly send said command to said command processing apparatus in association with an instruction by said first instructing means.

9. A server according to claim 8, further comprising:
a load determining means for determining whether or not a load is below a second threshold value before said data amount determining means performs a determination; and a first invalidating for invalidating said data amount determining means when a determination result by said load determining means is affirmative, wherein
said first sending means perform a sending when the determination result by said load determining means is affirmative.

10. A server according to claim 9, further comprising:
a charge determining means for determining whether or not processing according to said command is an object to be charged before said load determining means performs a determination; and a second invalidating means for invalidating said data amount determining means and said load determining means when a determination result by the said charge determining means is affirmative, wherein
said first sending means performs a sending when the determination result by said charge determining means is affirmative.

11. A mediating method mediating a data communication between a command processing apparatus and a process requesting apparatus, comprising:
a determining step for, when a send request for requesting to send a command to a command processing apparatus is accepted from a process requesting apparatus, determining whether or not said process requesting apparatus satisfies a predetermined condition;
a first sending step for sending said command to said command processing apparatus when a determination result by said determining step is negative;
a receiving step for receiving from said command processing apparatus an execution result of said command sent by said first sending step;
a second sending step for sending the execution result received by said receiving step to said process requesting apparatus;
a first instructing step for instructing said command processing apparatus to perform preparation processing for receiving said command when the determination result by said determining step is affirmative; and
a second instructing step for instructing said process requesting apparatus to directly send said command to said command processing apparatus in association with an instruction by said first instructing step.

12. A control program to be executed by a processor of a server mediating a data communication between a command processing apparatus and a process requesting apparatus, comprising:
a determining step for, when a send request for requesting to send a command to a command processing apparatus is accepted from a process requesting apparatus, determining whether or not said process requesting apparatus satisfies a predetermined condition;
a first sending step for sending said command to said command processing apparatus when a determination result by said determining step is negative;
a receiving step for receiving from said command processing apparatus an execution result of said command sent by said first sending step;
a second sending step for sending the execution result received by said receiving step to said process requesting apparatus;
a first instructing step for instructing said command processing apparatus to perform preparation processing for receiving said command when the determination result by said determining step is affirmative; and
a second instructing step for instructing said process requesting apparatus to directly send said command to said command processing apparatus in association with an instruction by said first instructing step.

13. A recording medium recording a control program to be executed by a processor of a server mediating a data communication between a command processing apparatus, wherein said control program comprises:
a determining step for, when a send request for requesting to send a command to a command processing apparatus is accepted from a process requesting apparatus, determining whether or not said process requesting apparatus satisfies a predetermined condition;
a first sending step for sending said command to said command processing apparatus when a determination result by said determining step is negative;
a receiving step for receiving from said command processing apparatus an execution result of said command sent by said first sending step;
a second sending step for sending the execution result received by said receiving step to said process requesting apparatus;
a first instructing step for instructing said command processing apparatus to perform preparation processing for receiving said command when the determination result by said determining step is affirmative; and
a second instructing step for instructing said process requesting apparatus to directly send said command to said command processing apparatus in association with an instruction by said first instructing step.

14. A mediating method mediating a data communication between a command processing apparatus and a process requesting apparatus, comprising:
a data amount determining step for, when a send request for requesting to send a command to a command processing apparatus is accepted from a process requesting apparatus, determining whether or not a data amount included in an execution result of said command is above a first threshold value;
a first sending step for sending said command to said command processing apparatus when a determination result by said data amount determining step is negative;
a receiving step for receiving from said command processing apparatus an execution result of said command sent by said first sending step;
a second sending step for sending the execution result received by said receiving step to said process requesting apparatus;
a first instructing step for instructing said command processing apparatus to perform preparation processing for receiving said command when the determination result by said data amount determining step is affirmative; and
a second instructing step for instructing said process requesting apparatus to directly send said command to said command processing apparatus in association with an instruction by said first instructing step.

15. A control program to be executed by a processor of a server mediating a data communication between a command processing apparatus and a process requesting apparatus, comprising:
a data amount determining step for, when a send request for requesting to send a command to a command processing apparatus is accepted from a process requesting apparatus, determining whether or not a data amount included in an execution result of said command is above a first threshold value;
a first sending step for sending said command to said command processing apparatus when a determination result by said data amount determining step is negative;
a receiving step for receiving from said command processing apparatus an execution result of said command sent by said first sending step;
a second sending step for sending the execution result received by said receiving step to said process requesting apparatus;
a first instructing step for instructing said command processing apparatus to perform preparation processing for receiving said command when the determination result by said data amount determining step is affirmative; and
a second instructing step for instructing said process requesting apparatus to directly send said command to said command processing apparatus in association with an instruction by said first instructing step.

16. A recording medium recording a control program to be executed by a processor of a server mediating a data communication between a command processing apparatus, wherein said control program comprises:
a data amount determining step for, when a send request for requesting to send a command to a command processing apparatus is accepted from a process requesting apparatus, determining whether or not a data amount included in an execution result of said command is above a first threshold value;
a first sending step for sending said command to said command processing apparatus when a determination result by said data amount determining step is negative;
a receiving step for receiving from said command processing apparatus an execution result of said command sent by said first sending step;
a second sending step for sending the execution result received by said receiving step to said process requesting apparatus;
a first instructing step for instructing said command processing apparatus to perform preparation processing for receiving said command when the determination result by said data amount determining step is affirmative; and
a second instructing step for instructing said process requesting apparatus to directly send said command to said command processing apparatus in association with an instruction by said first instructing step.
